(19) United States
(12) Patent Application Publication
(10) Pub. No.: US 2009/0274014 A1
(43) Pub. Date: Nov. 5, 2009

(54) Calculating clock (multiplication figure)

(75) Inventor: Ali Ashour Al-Jafar, Kuwait City (KW)

Correspondence Address: FURR LAW FIRM, 2622 DEBOLT ROAD, UTICA, OH, 43080, US

(73) Assignee: University of Kuwait, Safat (KW)

(21) Appl. No.: 12/113,328

(22) Filed: May 1, 2008

(51) Int. Cl. G04B 19/06

(52) U.S. Cl. 368/232

(57) ABSTRACT

The invention is a clock with of two interrelated parts. The first utilizes the clock (time measuring device/timepiece) so that the multiplication table maybe obtained therefore in an easy, orderly manner, hence division operations maybe performed in an opposite way. The second is to design the clock embodying the 1×1 to 12×12 multiplication table called a “Formation (Genesis) clock, as the 12×12 table results in number 144, which is equivalent to the total of six days, representing the days of creation and formation (genesis), as mentioned in the Holy Quran and the Bible (Old Testament). Utilizing the clock (time measuring device/timepiece) so that the multiplication table maybe obtained therefore in an easy, orderly manner, hence division operations maybe performed in an opposite way.

### FIELD OF THE INVENTION

The field of the present invention relates generally to a clock allowing multiplication tables to be obtained easily to solve the multiplication table for grade three and up in the elementary school in an easy and fun way.

### BACKGROUND OF THE INVENTION

The teaching of multiplication tables to children is very often difficult and tedious task. Most common method deal with memorization of the table. There exists a need to make this simplier and in an easy and fun way.

### SUMMARY OF THE INVENTION

The Concept of the invention to solve the multiplication table for grade three and up in the elementary school in an easy and fun way consists of two interrelated parts:

I—Utilizing the clock (time measuring device/timepiece) so that the multiplication table maybe obtained therefore in an easy, orderly manner, hence division operations maybe performed in an opposite way.

II—Designing a clock embodying the 1×1 to 12×12 multiplication table called a “Formation (Genesis) clock, as the 12×12 Figure results in number 144, which is equivalent to the total of six days, representing the days of creation and formation (genesis), as mentioned in the Holy Quran and the Bible (Old Testament).

### BRIEF DESCRIPTION OF THE DRAWINGS

The above and other aspects, features, and advantages of the present invention will be better and more fully understood by those skilled in the art with reference to the following detailed an more particular description of specific and preferred embodiments thereof, resented in conjunction with the following drawings to show how the same may be carried into effect, wherein:

FIG. 1 displays a clock face with a full 1×12 half day;

FIG. 2 displays a clock face with a full 2×12 Full day;

FIG. 3 displays a clock face with a full 3×8=24 Full day;

FIG. 4 displays a clock face with a full 4×6=24 Full day;

FIG. 5 displays a clock face with 4×1=3 (the right corner)+1 (the multiplier)=4 4×2=6 (the bottom corner)+2 (the multiplier)=8;

FIG. 6 displays a clock face with a full 6×4=24 Full day;

FIG. 7 displays a clock face governed by the idea of opposition;

FIG. 8 displays a clock face similar to FIG. 4 except for doubling the number of days, as FIG. 8 takes four of the Formation days;

FIG. 9 displays four and a half of the Formation days;

FIG. 10 displays a the product of 10 and any number appears on the circumference of the circles;

FIG. 11 displays a the product of 11 and any number appears moving in an anti-clockwise direction;

FIG. 12 displays a the product of 12 and any other number appears as a movement in a straight upward direction from one circle to the next up to the twelfth circle, representing the six formation days;

FIG. 13 displays the overall single circle model; and

FIG. 14 displays the overall detailed circle model.

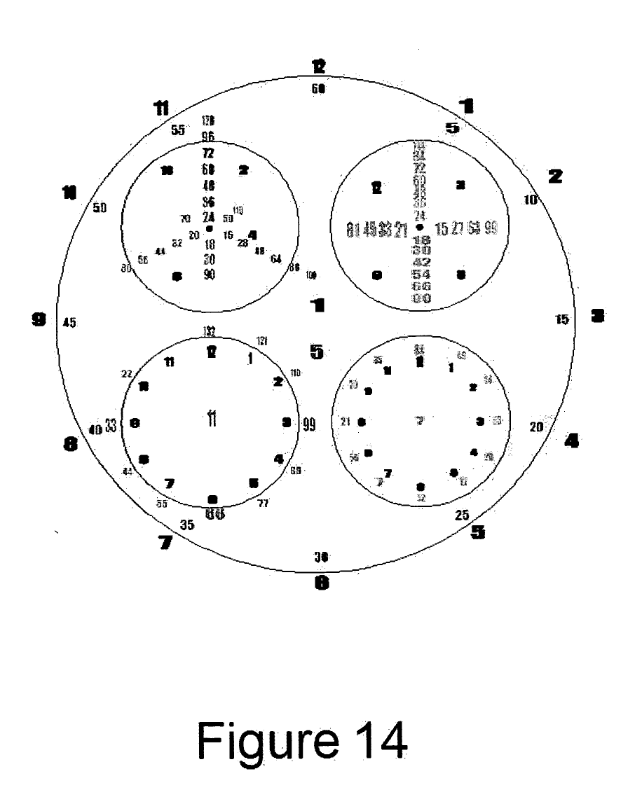

### DETAILED DESCRIPTION OF THE INVENTION

The current invention uses a Clock (measuring device) and clock face that consists of twenty four hours in respect of the full day covering an area of the multiplication table as follows:

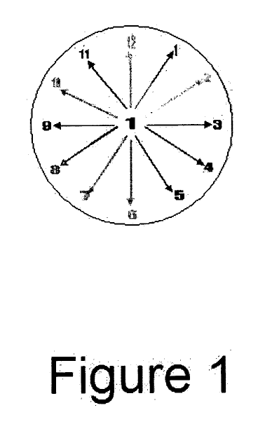

FIG. 1 in full 1×12 half day,

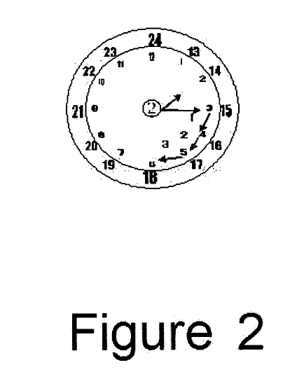

FIG. 2 in full 2×12 Full day,

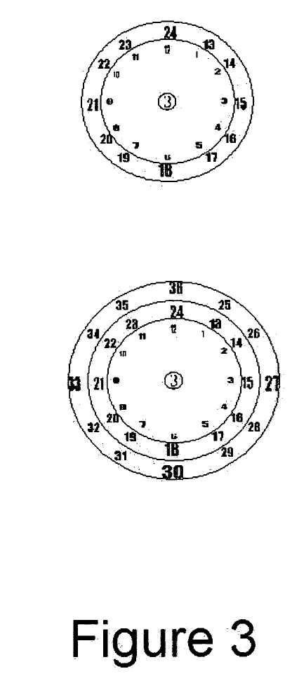

FIG. 3 to 8 3×8=24 Full day,

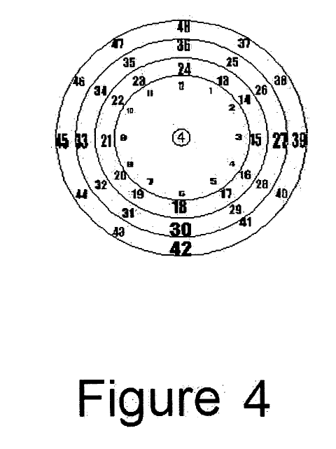

FIG. 4 to No. 6 4×6=24 Full day, and

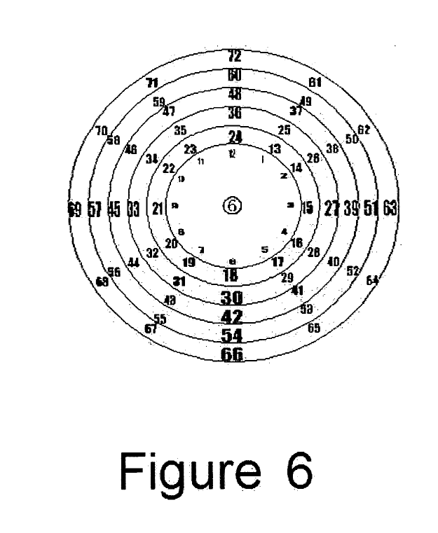

FIG. 6 to No. 4 6×4=24 Full day.

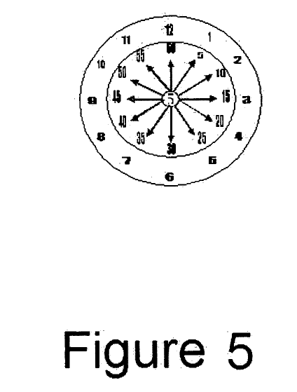

The product in respect of FIG. 5 in full is obtained from the movement of the second hand (60 seconds=one minute) as follows:

5×1=5

To 5×12=60 seconds.

FIG. 5 takes on the shape of FIG. 1 but on the second circle. As the maximum limit of the clock (i.e. the time measuring device) is 24, which covers the whole of FIGS. 1 and 2, and FIGS. 3, 4, 5, and 6 partially in varying degrees, and in order to cover the rest of the tables, it is necessary to design the Formation Clock (the second part of the invention) to cover the whole system of multiplication tables (and hence division) from the 1×1 to 12×12 table.

The Concept of the invention consists of two interrelated parts:

I—Utilizing the clock (time measuring device/timepiece) so that the multiplication table maybe obtained therefore in an easy, orderly manner, hence division operations maybe performed in an opposite way.

II—Designing a clock embodying the 1×1 to 12×12 multiplication table. This is called a “Formation (Genesis) clock, as the 12×12 Figure results in number 144, which is equivalent to the total of six days, representing the days of creation and formation (genesis), as mentioned in the Holy Quran and the Bible (Old Testament).

I—The Calculating Clock (Multiplication Figure)

The Clock (measuring device) consists of twenty four hours in respect of the full day covering an area of the multiplication tables as follows:

FIG. 1 in full 1×12 half day,

FIG. 2 in full 2×12 Full day,

FIG. 3 to No. 8 3×8=24 Full day,

FIG. 4 to No. 6 4×6=24 Full day, and

FIG. 6 to No. 4 6×4=24 Full day.

The product in respect of FIG. 5 in full is obtained from the movement of the second hand (60 seconds=one minute) as follows:

To 5×12=60 seconds.

To 5×12=60 seconds.

FIG. 5 takes on the shape of FIG. 1 but on the second circle.

II. Formation Clock:

As the maximum limit of the clock (i.e. the time measuring device) is 24, which covers the whole of FIGS. 1 and 2, and FIGS. 3, 4, 5, and 6 partially in varying degrees, and in order to cover the rest of the tabless, it is necessary to design the Formation Clock (the second part of the invention) to cover the whole system of multiplication tables (and hence division) from the 1×1 to 12×12 Figure, as detailed below:

In FIG. 1, the answers are represented in the number appearing on the clock circumference, as shown in the following manner:

Example:

1×1=1

1×2=2.

In FIG. 2, the method of using the calculating clock to obtain the product of 2 and any number (up to 12) may be shown as follows:

2×3, subject to the following:

A. The multiplier (2) occupies the centre of the circle

B. Start the process of obtaining the product from the multiplier (3) on the Circumference of the full day's circle.

C. We move clockwise three steps from 2, which represents the multiplier.

D. With the above operation, we reach (6), which is the product of 2×3. The above is repeated until we arrive at the product of 2 and any other numbers up to 12.

In FIG. 3 it shows the product of 3 and any other number representing the four corners of the clock's circle, namely:

3, 6, 9, 12 in respect of the half day circle.

15, 18, 21, 24 in respect of the second half of the day.

This is shown from the following:

| | |
|---|---|
| 3 × 1 = 3 | Right Corner |
| 3 × 2 = 6 | Bottom Corner |
| 3 × 3 = 9 | Left Corner |
| 3 × 4 = 12 | Top Corner |

The Above process is repeated to obtain the product of 3 and the other numbers on the corners of the second circle which completes the full day.

From the above table, it is noted that FIG. 3 on the full day's circle will stop at 3×8=24, and to know the product of 3 and 9 and the subsequent numbers, the user has to enter the new (next) day, hence the need for the second part of the invention, namely the Formation Clock, which covers the other Figures up to 12×12, a total of six days.

In FIG. 4, the numbers representing the four corners of the clock's circle are:

| | |
|---|---|
| 3, 6, 9, 12, 15, 18, 21, 24 | in respect of the first day |
| 27, 30, 33, 36, 39, 42, 45, 46 | in respect of the second day. |

The product of 4×1 (e.g.) in the right corner (3) plus the multiplier (1).

i.e.

4×1=3(the right corner)+1(the multiplier)=4

4×2=6(the bottom corner)+2(the multiplier)=8

And so on with the other numbers.

In FIG. 5 as it has previously been referred, to obtain it in full, the user follows the movement of the second hand (see what is said about this Figure in the Calculating Clock, previously referred to).

In FIG. 6 obtaining the product of 6 and any number requires that the number of circles be increased to six, representing a total of 72 hours (6×12), the equivalent of three of the formation days.

The Product of 6 and any number will appear in the bottom and top corners respectively in the six circles.

Example:

6×5=30(the bottom corner of the fourth circle, representing Day 2)

6×10=60(the top corner of the fifth circle, representing Day 3)

And so on with the other numbers.

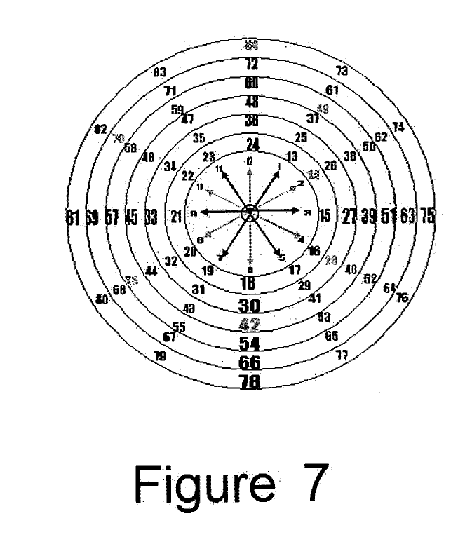

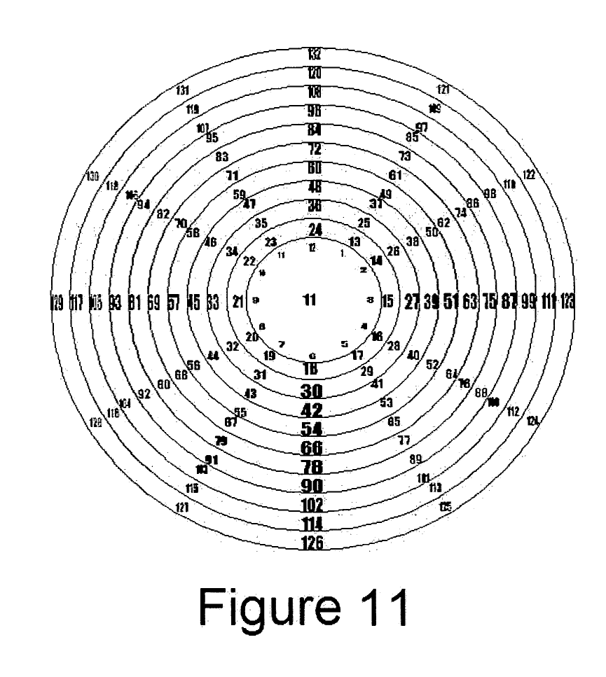

FIG. 7 is readily distinguished from the previous and subsequent Figures, except FIG. 11, as it will be shown below.

FIG. 7 is governed by the idea of opposition rather than the corners of the clock previously referred to. To make this idea clear, we say that each number on the circumference of the clock (measuring device) has an opposite number on the opposite side, as it is known.

The number 1 is opposite to the number 7

The number 3 is the opposite to the number 9

The number 6 is opposite to the number 12, etc.

The product of 7 and any even number appears on the head of an arrow pointing from the circle's centre. To the circumference in a straight line.

Example:

7×2=14(the second circle of Day 1)

7×4=28(the third circle of Day 2)

7×8=56(the fifth circle of Day 3)

The product of 7 and any odd number appears on the head of an arrow pointing from the circle's centre to the circumference in the opposite direction.

Example:

7×3=21(the second circle of Day 1)

7×5=35(the third circle of Day 2)

7×9=63(the sixth circle of Day 3)

It is extremely important to note that FIG. 7 requires seven circles, the equivalent of three and a half of the formation days.

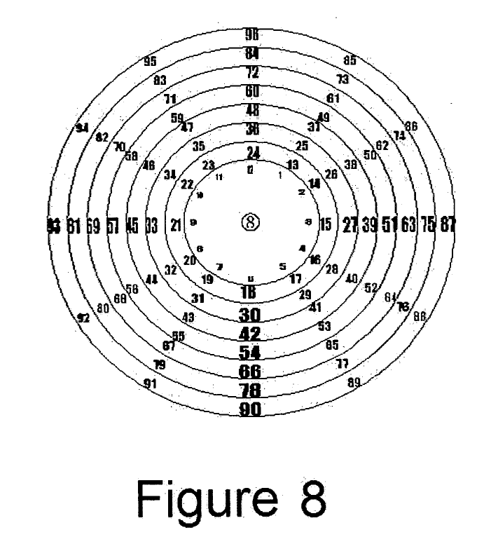

FIG. 8 is similar to FIG. 4 except for doubling the number of days, as FIG. 8 takes four of the Formation days. The product of 8 and any number appears on the circumference of the circles, as previously shown in FIG. 4, of course, the greater the number of days, the greater the product.

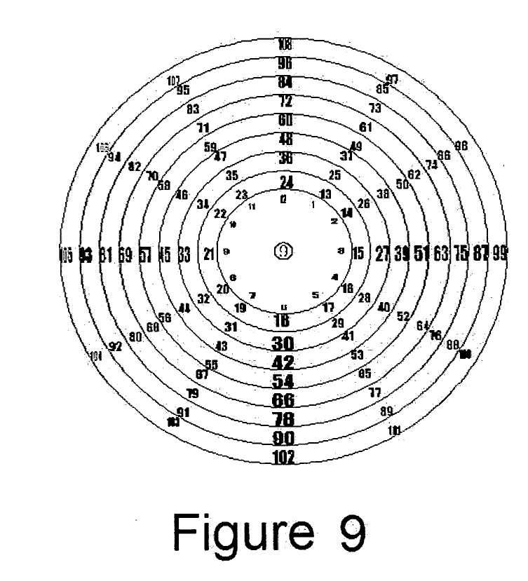

FIG. 9 differs from FIG. 3 and 6 only in terms of doubling the number of days, as FIG. 9 takes four and a half of the Formation days. The product of 9 and any number appears on the circumference of the circles, as previously shown in FIGS. 3 and 6.

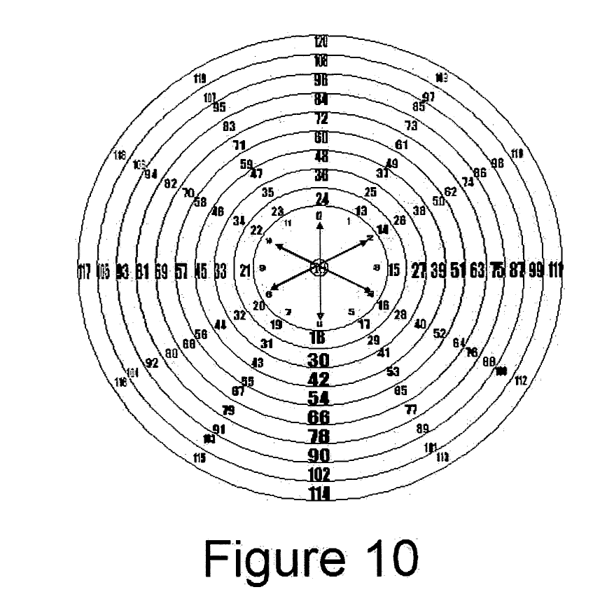

FIG. 10 differs from FIG. 2 only in terms of doubling the number of days, as FIG. 10 lasts for five of the formation days. The product of 10 and any number appears on the circumference of the circles, as previously shown in FIG. 2.

FIG. 11 shows the product of 11 and any number appears moving in an anti-clockwise direction. As the multiplier increases, the direction changes to the adjacent circle going gradually downwards to 66 (the product of 11 and 6 in the bottom corner of the sixth circle), then upwards to 132 (the product of 11 and 12 in the top corner of the eleventh circle). The Figure lasts for five and half of the formation days.

In the light of the above, the movement of FIG. 11 maybe characterized as similar to planets in orbit around the sun.

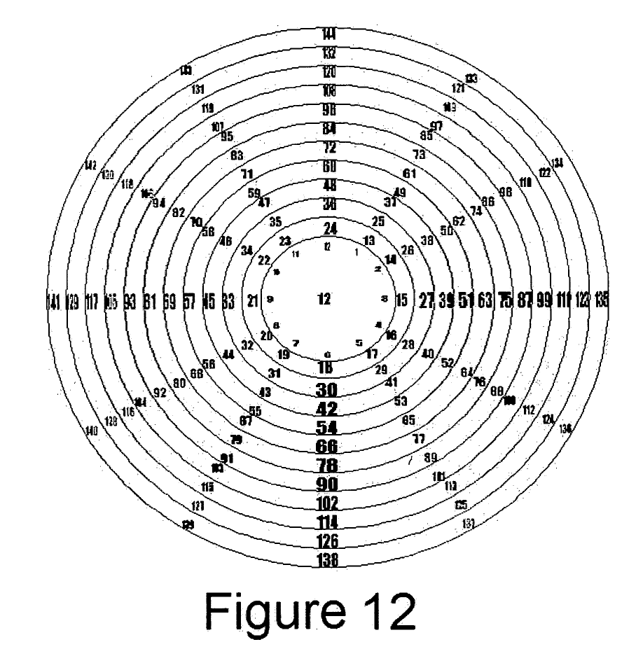

In FIG. 12 the product of 12 and any other number appears as a movement in a straight upward direction from one circle to the next up to the twelfth circle, representing the six formation days. In this way, the structure of the Formation Clock, the second part of the invention, is completed.

III—The Overall Model of the Formation Clock

The subsidiary models which make up the Formation Clock may be summed up as follows:

I—The model based on the idea of corners covering FIGS. 3, 6, 9, 12.
It also covers FIGS. 2, 4, 8, and 10.

II—The model based on the idea of opposition: FIG. 7.

III—The model representing planet movement anti-clockwise: FIG. 11.

IV—The Model representing points on the circumference:
FIG. 1 on the circumference of the hours' circle
FIG. 5 on the circumference of the seconds' circle.

All of the above lead us to the overall diagram of the Formation Clock, which may be represented in two ways:

First: The overall single circle model as shown in FIG. 12.

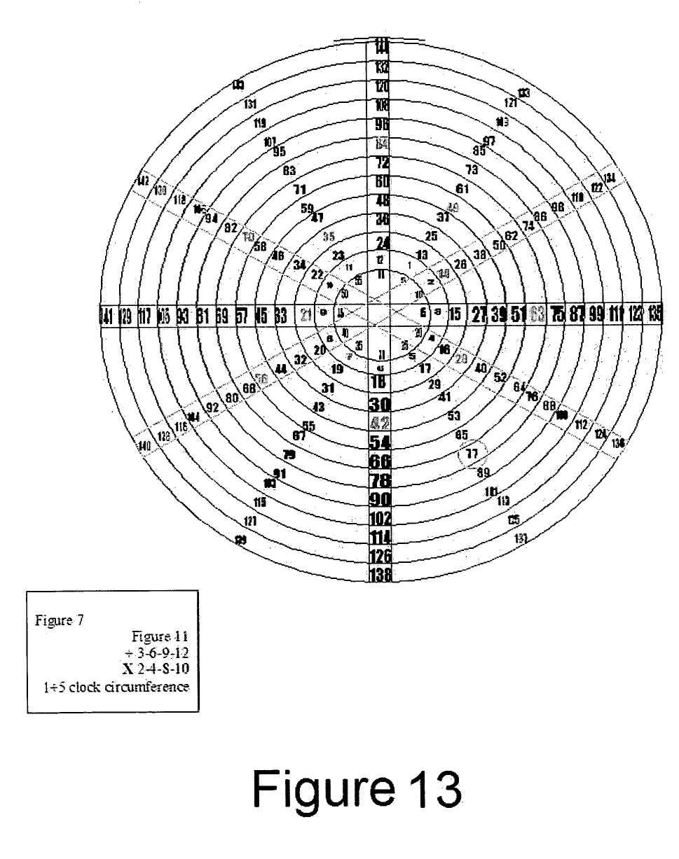

Second: The overall detailed circle model as shown in FIG. 13.

Both models may present a proposed diagram for manufacturing the Formation Clock.

The hands of the Clock play a key role in showing the result (product): the hour hand will represent the multiplication table, and the minute hand will represent the multiplier.

Example:

When it is 2.30, this means the table in question is 2 and the multiplier 6, i.e 2×6 When the two hands point to these numbers, the number 12 is lit to shown the answer. And so on for the other tables and numbers.

Advantages

The current invention shows multiplying Figures from FIG. 1 to FIG. 12 in an easy and fun way for the kids in the elementary school. It shows to them how they can find in the watch they have other things then just time.

The main advantage is to make the pupil in the elementary school appreciate knowledge and think differently in the things surrounding them. In addition, instead of memorizing FIG. 1 to 12, pupil will link math with other information and try to see knowledge integrated.

The methods of the present invention have been explained with reference to plurality of references the teachings of which are all incorporated herein by reference.

Equivalents

From the foregoing description, one skilled in the art can easily ascertain the essential characteristics of this invention and, without departing from the spirit and scope thereof, can make various changes and modifications of the invention to adapt it to various usages and conditions. Such variations and changes may include, for example, altering the number of components in the housing or using equivalents. It is believed that such can be accomplished without excessive experimentation. In any case, any such variations are all claimed under the scope of this invention.

We claim:

1. A clock comprising:
having a multiplication table on its face.

2. A clock according to claim 1 further comprising:
a single circle model.

3. A clock according to claim 1 further comprising:
a detailed single circle model.

4. A clock according to claim 1 further comprising:
having a multiplication table of 1×12 equals a half day, 2×12 equals a Full day, 3×8=24 equals a Full day, 4×6=24 equals a Full day, and 6×4=24 equals a Full day.

5. A clock according to claim 1 further comprising:
using the circumference of the hours' circle with the multiplication table.

6. A clock according to claim 1 further comprising:
using the circumference of the seconds' circle with the multiplication table.

7. A clock according to claim 1 further comprising:
where In FIG. 3 it shows the product of 3 and any other number representing the four corners of the clock's circle where 3, 6, 9, 12 is in respect of the half day circle and 15, 18, 21, 24 in respect of the second half of the day.

8. A clock according to claim 7 further comprising:
where 3×1=3 is represent by the right corner of the clock face plate, 3×2=6 is represent by the bottom corner of the clock face plate, 3×3=9 is represent by the Left Corner of the clock face plate, and 3×4=12 is represent by the top Corner of the clock face plate.

9. A clock according to claim 1 further comprising:
where the multiplier is represent by the centre of the circle of the clock face, the process of obtaining the product from the multiplier on the Circumference of the full day's circle.

10. A clock according to claim 1 further comprising:
where the hands are moved clockwise the get the multiplier.

11. A process of during a multiplication table comprising:
having a clock with a multiplication table on its face.

12. A process according to claim 11 further comprising:
a single circle model.

13. A A process according to claim 11 further comprising:
a detailed single circle model.

14. A process according to claim 11 further comprising:
having a multiplication table of 1×12 equals a half day, 2×12 equals a Full day, 3×8=24 equals a Full day, 4×6=24 equals a Full day, and 6×4=24 equals a Full day.

15. A process according to claim 11 further comprising:
using the circumference of the hours' circle with the multiplication table.

16. A process according to claim 11 further comprising:
using the circumference of the seconds' circle with the multiplication table.

17. A process according to claim 11 further comprising:
where In FIG. 3 it shows the product of 3 and any other number representing the four corners of the clock's circle where 3, 6, 9, 12 is in respect of the half day circle and 15, 18, 21, 24 in respect of the second half of the day.

18. A process according to claim 17 further comprising:
where 3×1=3 is represent by the right corner of the clock face plate, 3×2=6 is represent by the bottom corner of the clock face plate, 3×3=9 is represent by the Left Corner of the clock face plate, and 3×4=12 is represent by the top Corner of the clock face plate.

19. A process according to claim 11 further comprising:
where the multiplier is represent by the centre of the circle of the clock face, the process of obtaining the product from the multiplier on the Circumference of the full day's circle.

20. A process according to claim 11 further comprising:
where the hands are moved clockwise the get the multiplier.
